(19) United States
(12) Patent Application Publication
(10) Pub. No.: US 2002/0107963 A1
(43) Pub. Date: Aug. 8, 2002

(54) Connection management system for managing telecommunication networks

(76) Inventor: Herve Gaudillat, Etats-Unis (FR)

Correspondence Address: Sughrue Mion Zinn, Macpeak & Seas, Suite 800, 2100 Pennsylvania Avenue NW, Washington, DC, 20037-3213, US

(21) Appl. No.: 10/048,626

(22) PCT Filed: Jun. 5, 2001
(86) PCT No.: PCT/FR01/01726

(30) Foreign Application Priority Data
Jun. 5, 2000 (FR) 00 07 142

(51) Int. Cl. G06F 15/173

(52) U.S. Cl. 709/225

(57) ABSTRACT

The invention relates to a network element connection management system. The system includes:

a subsystem (A) for managing the availability and use of the capacities of resources which offers services for verifying the availability of resources and for reserving said resources, and

a topology server application (S) which provides information on the network elements (termination points and their characteristics),

said subsystem (A) and said application (S) co-operating via a communication software bus (B), said subsystem for managing the availability and use of resources thus being adapted to offer its services to application programs via said communication bus (B), for example connection path and/or routing management.

The invention relates to a connection management system for managing telecommunication networks, in particular managing the availability and use of physical resources.

Telecommunication network management corresponds to an information system able to provide a knowledge of the physical resources, namely the network elements (NE), also known as nodes, their termination points and the properties of the termination points.

The termination points are called access points in an Asynchronous Transfer Mode (ATM) network.

The termination points have technical characteristics having properties dedicated to the connectivity aspect. It is those properties that are of interest hereinafter. They include capacity in terms of bandwidth (input bandwidth, output bandwidth), capacity in terms of the maximum number of connection paths, and capacity in terms of identifying connection paths that can be allocated.

The information system is based on three levels of software.

A first level is the Equipment Management Layer (EML). This is primarily the application layer responsible for the interface with the network element NE, enabling the status of the element to be determined and management commands to be sent to the element.

A second level is the Network Management Layer (NML). This layer controls management of paths handling calls in a network.

A third level is the Services Management Layer (SML). This layer is dedicated to service management. For example, it manages private networks constructed from the network of a telecommunications operator.

The problem solved by this patent application is that of providing a flexible software architecture for implementing connection management in telecommunication networks. To be more specific, the problem is that of providing a connection management system including a subsystem consisting of a generic component that can be adapted to suit different technologies, for example the ATM network technology or the Frame Relay technology.

Thus an object of the present invention is to solve the above problem.

To this end the invention proposes a component for managing the availability and use of network element resources at the NML and SML level, said component being a subsystem of the connection management system.

The solution proposes to separate the aspects of management that are generic from those which are specific to the technology of a network, and to use a software (CORBA) bus to enable interworking of modules of the management subsystem and external client applications.

At present telecommunication resource management does not use any generic component for managing the availability and use of telecommunication resources.

The invention therefore provides a telecommunication network element connection management system, mainly characterized in that it includes:

a subsystem for managing the availability and use of resources which offers services for verifying the availability of resources and for reserving said resources, and

a topology server application which provides information on the network elements,

said subsystem and said application co-operating via a communication software bus, said subsystem for managing the availability and use of resources thus being adapted to offer its services to application programs via said communication bus (for example switchpath management and/or routing programs).

In a preferred embodiment, to minimize the impact of the technology on future developments, the architecture of the subsystem is an object-oriented architecture.

According to another feature, the subsystem for managing the availability and use of resources includes a server module and a client module of said server module.

According to another feature, the server includes a nucleus defining all generic behaviors and an extension for configuring and programming behaviors specific to a given technology (for example the ATM or Frame Relay technology).

According to another feature, the client module includes a nucleus defining all the generic behaviors and an extension for configuring and programming behaviors specific to a given technology (for example the ATM or Frame Relay technology).

Other features and advantages of the invention will become clearly apparent on reading the following description, which is given by way of illustrative and non-limiting example and with reference to the drawings, in which:

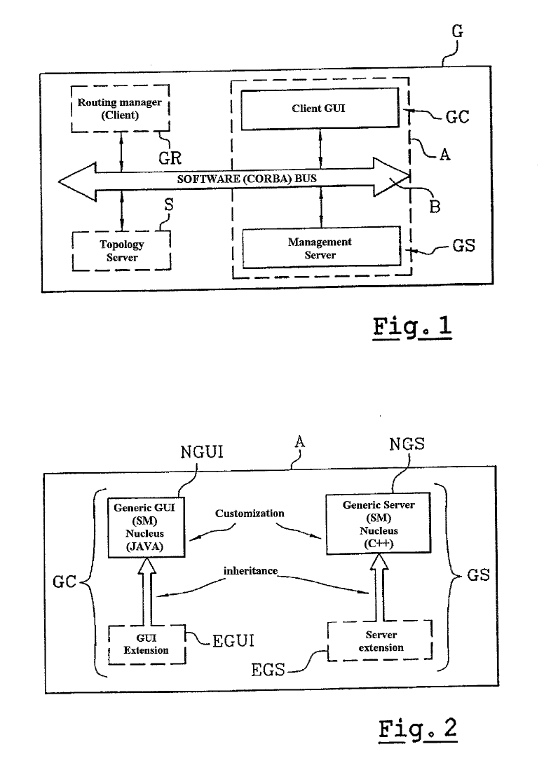

FIG. 1 is a general diagram of the invention, and

FIG. 2 is a more detailed diagram of the component for managing the availability and use of resources capacities.

FIG. 1 is a diagram showing the architecture of a connection management system according to the invention. The connection management system G includes:

a subsystem A for managing the availability and use of resources. This subsystem includes a management server GS and a client module GC; the client module is a graphical user interface application GUI;

a topology server S which supplies information on the network elements, the termination points of said elements and their respective properties: bandwidth, maximum number of switchpaths and identifier of switchpaths that can be allocated;

a communication software bus B; the data exchanged via this bus is defined via a communication interface (IDL interface) enabling interworking in accordance with the CORBA standard to enable communication between the component A for managing the availability and use of resources and the topology server S, so that they can co-operate in the provision of services to verify the availability of resources and to reserve resources.

The management server GS offers services for verifying the availability of resources and reserving resources to applications external to the component A (for example the routing manager application GR) and to the graphical user interface module GC. These services are provided by the server GS for managing the use of capacities via a CORBA software bus.

The management component A enables redefinition of the behaviors by software inheritance on the server GS side and on the GUI side (in C++ on the server side and in JAVA on the GUI side).

Communications between the modules/applications are therefore effected via the CORBA communication bus B (this includes applications external to the component, such as the routing manager GR).

FIG. 2 shows the architecture of the component A in more detail.

The management server module GS includes a generic nucleus NGS defining behaviors common to all the technologies, in other words generic behaviors.

The server module GS also includes an extension EGS for configuring and programming components specific to a particular technology. By default, the extension EGS is adapted to suit the ATM technology.

In the same way, the module GC, which is a client application of the server module GS, includes a generic nucleus NGUI defining behaviors common to all the technologies, in other word generic behaviors.

This module GC also includes an extension EGUI for configuring and programming behaviors specific to a particular technology. By default, the extension EGS is adapted to suit the ATM technology.

1. A network element connection management system, characterized in that it includes:
a subsystem (A) for managing the availability and use of resources which offers services for verifying the availability of resources and for reserving said resources, and
a topology server application (S) which provides information on the network elements,
said subsystem (A) and said application (S) co-operating via a communication software bus (B), said subsystem for managing the availability and use of resources thus being adapted to offer its services to application programs via said communication bus (B).

2. A connection management system according to claim 1, wherein the architecture of the subsystem (A) is an object-oriented architecture.

3. A connection management system according to claim 1 or claim 2, wherein the subsystem (A) for managing the availability and use of resources includes a server module (GS) for managing the availability and use of resources and a client module (GC) of said server module.

4. A connection management system according to claim 3, wherein the management server module (GS) includes a nucleus (NGS) defining all generic behaviors and an extension (EGS) for configuring and programming behaviors specific to a given technology.

5. A connection management system according to claim 3, wherein the client module (GC) includes a nucleus (NGUI) defining all the generic behaviors and an extension (EGUI) for configuring and programming behaviors specific to a given technology.

6. A connection management system according to claim 5, wherein the client module (GC) is a graphical user interface (GUI).
